(19) United States
(12) Patent Application Publication
(10) Pub. No.: US 2026/0247188 A1
(43) Pub. Date: Aug. 20, 2026

(54) INTERRUPTION ARRANGEMENT FOR GAPLESS MEASUREMENTS

(71) Applicant: Apple Inc., Cupertino, CA (US)

(72) Inventors: Qiming Li, Beijing (CN); Manasa Raghavan, Sunnyvale, CA (US); Yuqin Chen, Beijing (CN); Yang Tang, San Jose, CA (US); Dawei Zhang, Saratoga, CA (US); Xiang Chen, Campbell, CA (US); Haijing Hu, Los Gatos, CA (US); Jie Cui, San Jose, CA (US)

(21) Appl. No.: 18/995,290

(22) PCT Filed: Jul. 27, 2023
(86) PCT No.: PCT/US2023/028765

§ 371 Date: Jan. 16, 2025

(51) Int. Cl. H04W 24/10; H04W 76/20

(52) U.S. Cl. CPC H04W 24/10; H04W 76/20

(57) ABSTRACT

Techniques, described herein, include solutions for interruption arrangement for a User Equipment (UE) performing gap-less measurements. Traditionally, a UE configured a time duration, known as a measurement gap, to prepare Radio Frequency (RF) circuitry for performing measurement and to perform measurement. By using spare RF circuitry to perform measurement, a UE may perform ‘gap-less’ measurement without a measurement gap. When preparing for gapless measurement, interruption may occur depending on many factors that may vary depending on the UE and the currently active frequency bands. The UE may use interrupts for the time required to prepare the spare RF circuitry to perform gapless measurement. The UE may communicate to the network a temporal location, and a duration, of the interrupts via various information elements (IEs), so that the network may know when interrupts are allocated.

### REFERENCE TO RELATED APPLICATIONS

This Application claims the benefit of U.S. Provisional Application No. 63/393,291, filed on Jul. 29, 2022, the contents of which are hereby incorporated by reference in their entirety

### FIELD

This disclosure relates to wireless communication networks including techniques for conserving power within wireless communication networks.

### BACKGROUND

Wireless communication networks may include user equipments (UEs), base stations, and/or other types of wireless devices capable of communicating with one another. During operation, a UE may measure signal quality of an active cell and/or neighboring cells to facilitate handover, carrier aggregation, and so on for enhanced performance.

### BRIEF DESCRIPTION OF THE DRAWINGS

FIG. 1 is a block diagram illustrating a wireless network including a user equipment (UE) to perform gapless measurements in accordance with some aspects of the present disclosure.

FIG. 2 is a schematic diagram illustrating signaling between a UE and a base station for an interruption arrangement for performing gapless UE measurements in accordance with some aspects of the present disclosure.

FIG. 3 is a schematic diagram illustrating an interruption arrangement for gapless UE measurements in accordance with some aspects of the present disclosure.

FIG. 4 is a schematic diagram illustrating an interruption arrangement for gapless UE measurements in accordance with some additional aspects of the present disclosure.

FIG. 5A-5B are schematic diagrams illustrating interruption arrangements for gapless UE measurements in accordance with some additional aspects of the present disclosure.

FIG. 6 is a schematic diagram illustrating an interruption arrangement for gapless UE measurements in accordance with some additional aspects of the present disclosure.

FIG. 7 is a schematic diagram illustrating an interruption arrangement for gapless UE measurements in accordance with some additional aspects of the present disclosure.

FIG. 8 is a schematic diagram illustrating an interruption arrangement for gapless UE measurements in accordance with some additional aspects of the present disclosure.

FIG. 9 is a block diagram illustrating an interruption eligibility parameter in accordance with some aspects of the present disclosure.

FIG. 10A-10C are diagrams illustrating tables of an interruption eligibility parameter in accordance with some aspects of the present disclosure.

FIG. 11A is a diagram illustrating an interruption length parameter in accordance with some aspects of the present disclosure.

FIG. 11B-11E are diagrams illustrating tables of an interruption length parameters in accordance with some aspects of the present disclosure.

FIG. 12 is a flow diagram illustrating a method for performing gapless UE measurements in accordance with some aspects of the present disclosure.

FIG. 13 is a block diagram illustrating a device that can be employed to perform gapless UE measurements in accordance with some aspects of the present disclosure.

FIG. 14 is a block diagram illustrating baseband circuitry that can be employed to perform gapless UE measurements in accordance with some aspects of the present disclosure.

### DETAILED DESCRIPTION

The following detailed description refers to the accompanying drawings. The same reference numbers may be used in different drawings to identify the same or similar elements. Additionally, the present disclosure is not limited to the following description as other implementations may be utilized, and structural or logical changes made, without departing from the scope of the present disclosure. For the purpose of the present document, the term “a processor” refers to one or more processors, and the term “A or B” refers to (A), (B), or (A and B).

A user equipment (UE) may measure signal quality of an active cell and/or neighboring cells to facilitate procedures such as handover, carrier aggregation, and so on. Introduced in 5G, synchronization signal/physical broadcast channel (SS/PBCH) blocks (SSBs) are used for UE measurement. For each cell, one or more SSBs is/are allocated to beams extending in different directions from that cell and is/are transmitted in a “burst” across the allocated beams. The burst transmission falls within an SSB measurement timing configuration (SMTC) window, and may comprise sweeping across the allocated beams and transmitting the one or more SSBs at each of the allocated beams.

The cells may be spread across multiple carrier frequencies, such as multiple frequency bands, multiple carrier frequencies, multiple radio access technology (RATs), multiple bandwidth parts (BWPs) within a frequency band, or any combination of the foregoing. To measure signals from cells spread as above, Radio Frequency (RF) resources (e.g., chains, baseband circuitry, etc.) may depend on retuning. The retuning may involve transitioning RF resources from being used for communication on one frequency band to a different and second frequency band to conduct a measurement on the second frequency band. However, retuning may disrupt transmission/reception of data. Therefore, measurement gaps beginning before and ending after SMTC windows may be allocated for UE measurement.

Measurement gaps correspond to periods at which transmission and reception of data on at least one frequency band are suspended in order to, in some instances, conduct measurements on a different frequency band, whereby measurement gaps reduce transmit/receive efficiency. Therefore, a continuing goal in wireless communication is to reduce or eliminate measurement gaps.

To reduce or eliminate measurement gaps, New Radio (NR) Release 16 introduced gapless UE measurements. A UE capability parameter, NeedForGap (or NeedForGapsInfoNR, intraFreq-needForGap, interFreq-needForGap or other similar terms, hereafter referred as NeedForGap), is used to indicate the applicability of gapless UE measurements. UE reports either ‘gap’ or ‘no-gap’ for each band or band combination, where ‘gap’ indicates that a measurement gap needs to be configured for measuring a corresponding band, whereas ‘no-gap’ indicates that a measurement gap is not needed for measuring a corresponding band. Gapless UE measurements can reduce or eliminate the use of measurement gaps by using inactive RF resources for measurement, thereby improving system performance under conditions where gapless UE measurements can be applied. Such inactive RF resources may, for example, correspond to an RF chain and baseband circuitry for a secondary cell group (SCG) when carrier aggregation is disabled or otherwise off.

While some aspects of gapless UE measurements are defined, other aspects are undefined. For example, the inactive RF resources may cause interference in the active RF resources when switched on/off. Such switching may, for example, cause interference when the inactive RF resources share components with the active RF resources and/or when the inactive RF resources are used for measurement on a frequency band close to that of the active RF resources.

Because of the interference, it may be beneficial to allocate interrupts at which transmission/reception of data is suspended to allow the on/off switching. However, such interrupts are undefined. There may be certain limitations on when or if interrupts are allowed under certain circumstances. Further, to the extent that interrupts are allowed, there may be restrictions or specifications on when the interrupts are allowed, at what frequency the interrupts are allowed, and at what duration the interrupts are allowed for.

Accordingly, the present disclosure relates to an interrupt arrangement for gapless UE measurements. In some aspects, a UE may be configured to perform a first SSB measurement and a second SSB measurement respectively on a first carrier frequency and a second carrier frequency. The first and second SSB measurements are performed respectively within a first SMTC window and a second SMTC window. In some aspects, the first and second SSB measurements are performed based on an alignment of the first and second SMTC windows. Further, the first and second SSB measurements may, for example, be performed to detect signal conditions for potential carrier aggregation or handover frequency candidates while the UE is transmitting and/or receiving. Supposing the UE is capable of gapless measurement on at least the first carrier frequency (as disclosed in more detail hereafter), the present disclosure hereafter provides for various interruption arrangement aspects (e.g., eligibility, frequency, length, etc.) under different scenarios.

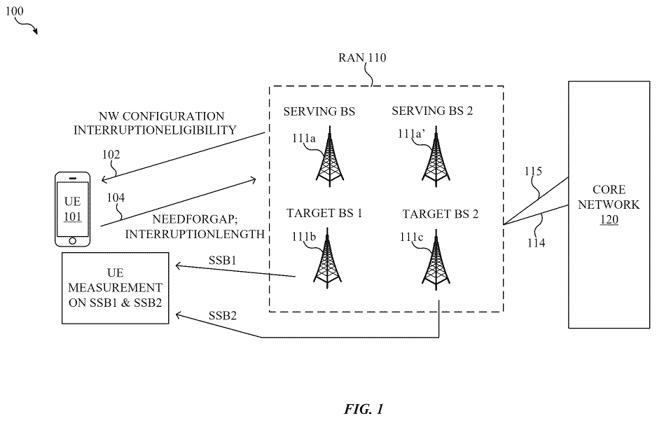

FIG. 1 illustrates an architecture of a network system 100 in accordance with some aspects. In some aspects, the network system 100 includes one or more UEs, including a UE 101. The UE 101 is illustrated as a smartphone (e.g., a handheld touchscreen mobile computing device connectable to one or more cellular networks), but can be or comprise any other mobile or non-mobile computing device. Such other mobile or non-mobile computing device may, for example, be or comprise a consumer electronics device, a cellular phone, a feature phone, a tablet computer, a wearable computer device, a personal digital assistant (PDA), a pager, a wireless handset, a desktop computer, a laptop computer, an in-vehicle infotainment (IVI) device, an in-car entertainment (ICE) device, an Instrument Cluster (IC), a heads-up display (HUD) device, an onboard diagnostic (OBD) device, dashtop mobile equipment (DME), a mobile data terminal (MDT), an Electronic Engine Management System (EEMS), an electronic/engine control unit (ECU), an electronic/engine control module (ECM), an embedded system, a microcontroller, a control module, an engine management system (EMS), a networked or “smart” appliance, a Machine Type Communication (MTC) device, a Machine to Machine (M2M) device, an Internet of Things (IoT) device, the like, or any combination of the foregoing.

The UE 101 can be configured to connect (e.g., communicatively couple) with a Radio Access Network (RAN) 110. The RAN may comprise a plurality of base stations 111a, 111a', 111b, 111c, each of which defines a cell and may perform one or more operations to enable SSB measurements as described below. In some aspects, the RAN 110 can be a Next Generation (NG) or Fifth Generation (5G) RAN, an evolved-Universal Mobile Telecommunications Service (UMTS) Terrestrial RAN (E-UTRAN), or a legacy RAN. In some aspects, the legacy RAN is a UTRAN, a Global System for Mobile Communications (GSM) Enhanced Data rates for GSM Evolution (EDGE) RAN (GERAN), or the like. As used herein, the term “NG RAN” or the like can refer to a RAN 110 that operates in a New Radio (NR) or 5G system, and the term “E-UTRAN” or the like can refer to a RAN 110 that operates in a Long Term Evolution (LTE) or Fourth Generation (4G) system. The UE 101 may utilize connections (or channels) 102, 104 comprising a physical communications interface/layer for downlink and uplink respectively.

In some aspects, the base station 111a may be a serving base station (or cells) that transmits and receives data with the UE 101. The base stations 111b, 111c may be neighboring base stations (or cells) that are not currently connected with the UE 101 but can be potential candidates for a handover procedure. The handover procedure may be initiated by the serving base station 111a as the UE 101 moves farther away from the serving base station 111a or experiences other situations that decrease the Signal-to-Noise Ratio (SNR) between the UE 101 and the serving base station 111a. For example, the handover procedure may handover the UE 101 from the serving base station 111a to one of the neighboring base stations 111b, 111c.

In some aspects, the network system 100 includes Multi-Radio Dual Connectivity (MR-DC). A group of serving base stations serves as a master cell group (MCG). The MCG comprises a primary cell (PCell) (e.g., the serving base station 111a) and optionally comprises one or more secondary cells (SCells) (not shown in the figure). To the extent that the MCG comprises the one or more SCells, the PCell and the one or more SCells coordinate via carrier aggregation. Another group of serving base stations serves as a secondary cell group (SCG). The SCG comprises a primary secondary cell (PSCell) (e.g., another serving base station 111a') and optionally comprises one or more SCells (not shown in the figure). To the extent that the SCG comprises the one or more SCells, the PSCell and the one or more SCells coordinate via carrier aggregation.

During a mobility handover procedure, the UE 101 is disconnected from a source PCell (e.g., the serving base station 111a) and connected with a target PCell (e.g., the first target base station 111b). In order to shorten signaling and procedure time, a target PSCell change or addition procedure may be performed in parallel with the PCell handover procedure, where a target PSCell (e.g., the second target base station 111c) may be added or changed from a source PSCell (e.g., another serving base station 111a') for the UE 101.

The network system 100 may, for example, have more or fewer devices and/or operations than those depicted in FIG. 1, and/or may, for example, have alternative devices or operations than those depicted in FIG. 1. For example, while concepts represented by FIG. 1 are applied above to a handover procedure and/or MR-DC, the concepts may also be applied to other network scenarios or events. Such other network scenarios or events may, for example, include adding a new carrier component (CC) for a carrier aggregation procedure. The carrier aggregation procedure may be used to increase bandwidth, and thereby increase a bit rate.

As seen above, the UE 101 may perform handover, carrier aggregation, MR-DC, the like, or any combination of the foregoing within the network system 100. In any of these scenarios, the UE 101 may perform concurrent SSB based measurements on multiple different carrier frequencies, such as multiple different RATs, multiple different band combinations, multiple frequency bands, multiple different BWPs within a frequency band, or any combination of the foregoing.

The UE 101 may be configured by a network configuration from the serving base station 111a to provide measurement gap requirement information for the target carrier frequencies. The UE 101 may transmit a gapless measurement capability parameter, NeedForGap, to the serving base station 111a to indicate whether the UE 101 is capable of gapless measurement per target frequency band or per FR1 or FR2, or a combination of the above. In some aspects of the disclosure, the serving base station 111a may transmit an interruption eligibility parameter, NeedForGap-InterruptionEligibility, to the UE 101. The interruption eligibility parameter indicates whether the UE 101 should perform/allocate interrupts outside all occurrences of a measurement gap, if the measurement gap is allocated for one or more frequency bands (e.g., for target base station 111b) but not allocated for one or more other frequency bands (e.g., for target base station 111c). An interrupt may be considered outside of the measurement gap if a portion of the interrupt is temporally offset from the measurement gap, such that the portion does not fall temporally within the measurement gap. In some additional aspects, the UE 101 may transmit an interruption length parameter, NeedForGap-InterruptionLength, to the serving base station 111a to indicate a length of the interrupt to be performed.

By introducing the interruption eligibility parameter, NeedForGap-InterruptionEligibility, the interruption allocation of the UE measurements may be based on the network signaling that may better fit measurement needs of the UE 101 and the RAN 110. For example, the interruption eligibility parameter, NeedForGap-InterruptionEligibility, may indicate that the interrupts shall be allocated outside of the measurement gap if a measurement associated with the interrupts has a high priority, or if there are a large number of carriers to be measured within the measurement gap. Conversely, the interruption eligibility parameter, NeedForGap-InterruptionEligibility, may indicate that the UE 101 should perform the measurement within the measurement gap without allocating additional interrupts outside of the measurement gap if the associated measurement has a low priority, or if there is a small number of carriers to be measured within the measurement gap.

The interruption length parameter, NeedForGap-InterruptionLength, delivers further flexibility and performance gains based on UE capability. In practice, many different types of UE 101 with varying capabilities may communicate with the RAN 110. For example, if the UE 101 has a high capability, it may indicate a shorter interruption length via the interruption length parameter, NeedForGap-InterruptionLength, which may increase the efficiency of the overall system. Conversely, if the UE 101 has a low capability, it may indicate a longer interruption length via the interruption length parameter, NeedForGap-InterruptionLength.

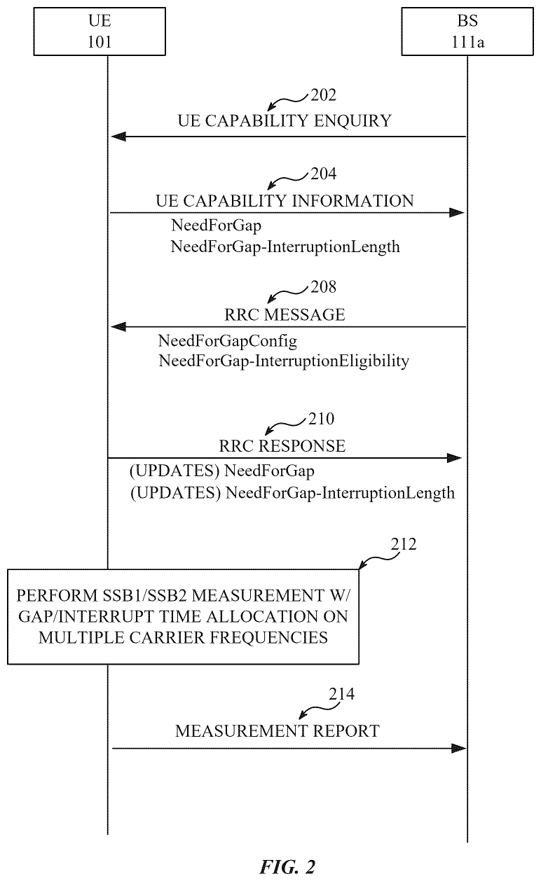

FIG. 2 illustrates a more detailed example of signaling procedure between a UE 101 and a base station 111a for an interruption arrangement for performing gapless UE measurements in accordance with some aspects. It is appreciated that the signaling between the UE 101 and the base station 111a may include fewer, additional, alternative, or differently arranged or sequenced operations as discussed or can be inferred from other aspects of the present disclosure.

As shown by act 202, in some aspects, the base station 111a may send a capability enquiry to the UE 101. The base station 111a may initiate the signaling procedure to the UE 101 when the UE 101 is in RRC_CONNECTED when it needs (additional) UE radio access capability information. The signaling may, for example, be by Radio Resource Control (RRC) signaling or the like. The capability enquiry may be a request for the UE 101 to respond with capability information.

As shown by act 204, in some aspects, the UE 101 may respond to the base station 111a with capability information, which may comprise a gapless measurement capability parameter (e.g., an information element (IE) NeedForGap). The capability information may additionally comprise an interruption length parameter (e.g., an IE NeedForGap-InterruptionLength) specifying a length for interrupts to be performed. The response may, for example, be by RRC signaling or the like.

As shown by act 208, in some aspects, network configuration information may be transmitted from the base station 111a to the UE 101. As an example, the network configuration information can be an RRC message, such as a RRCReconfiguration or RRCResume message triggered by an action. The triggering action may, for example, be handover, carrier aggregation, cell select/reselect, and so on. The RRC message includes information to setup, modify, or release measurements. The network configuration information includes SMTC parameters (e.g., patterns) defining timing, length, and periodicity for a first SMTC window allocated to a first carrier frequency and a second SMTC window allocated to a second carrier frequency. The network configuration information may also include a gapless measurement configuration parameter (e.g., an IE NeedForGapConfig) to configure the UE 101 to report measurement gap requirement information for target bands. Upon reception of the RRC message, the UE 101 shall consider itself to be configured to provide the measurement gap requirement information of target bands if the gapless measurement capability parameter is setup. Otherwise, the UE 101 is not configured to provide the measurement gap requirement information of target bands.

In some further aspect, the RRC message may also include an interruption eligibility parameter (e.g., an IE NeedForGap-InterruptionEligibility) for gapless measurement. The interruption eligibility parameter is to indicate whether the UE 101 shall perform gapless measurements outside of a measurement gap with interruptions. The interruption eligibility parameter may be indicated on a per carrier frequency basis, per measurement object (MO), or per FR1/FR2. A UE measurement shall be performed only within a measurement gap on a carrier frequency if the interruption eligibility parameter associated with the carrier frequency is a first value (e.g., a value that indicates interruption ineligibility). On the other hand, a UE measurement shall be performed on a carrier frequency outside measurement gaps with interruptions arranged respectively before and after an SMTC window if the interruption eligibility parameter associated with that carrier frequency is a second value (e.g., a value that indicates interruption eligibility).

In another further aspect, the interruption eligibility parameter could be indicated on a per UE basis. For example, if the interruption eligibility parameter is the first value, the UE 101 shall perform all measurements within measurement gaps. If the interruption eligibility parameter is the second value, the UE 101 shall perform all measurements outside of measurement gaps with interruptions arranged respectively before and after an associated SMTC window.

In some aspects, the interruption eligibility parameter may be based on the priority of the UE or the carrier frequency to be measured. If a low priority is determined, the interruption eligibility parameter may be the first value. Since the measurements are performed within measurement gaps, the scheduling of interruptions is minimized at the cost of larger time intervals between measurements. If a high priority is determined, the interruption eligibility parameter may be the second value. Since the measurements can be performed outside of measurement gaps, the time intervals between measurements are reduced, and SSBs can be more frequently measured with less delay, at the cost of more interruption scheduling being needed.

In some aspects, the RRC message may only include the gapless measurement configuration parameter if a gapless measurement needs to be (re)configured or updated. The RRC message may only include the interruption eligibility parameter if the interruption eligibility information needs to be added or updated.

As shown by act 210, in some aspects, the UE 101 sends RRC response to the base station 111a. The RRC response may comprise a gapless measurement capability parameter (e.g., an IE NeedForGap). In some aspects, the gapless measurement capability parameter may be indicated on a per band basis. If the gapless measurement capability parameter indicates ‘gap’ for a given band, then the UE 101 must perform measurements within measurement gaps on the given band. If the gapless measurement capability parameter indicates ‘no-gap’ for a given band, then the UE 101 may perform measurements outside of the measurement gaps on the given band.

In one example, the RRC response comprises a first gapless measurement capability parameter for a first carrier frequency (e.g., a first frequency band), and a second gapless measurement capability parameter for a second carrier frequency (e.g., a second frequency band). Each gapless measurement capability parameter may have a value of ‘gap’, indicating the UE is capable of gapless measurement on the corresponding carrier frequency, or a value of ‘no-gap’ indicating that the UE needs a measurement gap for the corresponding carrier frequency.

The indication on each band may be based on, for example, a UE capability to perform gapless measurement on each band. In some aspects, the UEs capability to perform gapless measurement depends on the spare RF resources available at the time. The spare RF resources available may vary depending on which frequency bands the UE 101 is currently communicating on.

The RRC response may additionally comprise an interruption length parameter (e.g., an IE NeedForGap-InterruptionLength) for gapless measurement.

The interruption length parameter indicates a length for interrupts allocated for gapless measurements. The UE 101 may determine the interruption length parameter, for example, based on a capability of the UE 101. In some aspects, the interruption length parameter may be indicated per frequency band. The indication on each frequency band may be, for example, based on a UE capability to measure on each frequency band. Depending on the spare RF resources available at the time, the UE may need a longer interrupt time to prepare the RF circuitry for measurement (e.g., RF switching on/off, etc.). The spare RF resources available may vary depending on which frequency bands the UE 101 is currently communicating on.

In some alternative aspects, the interruption length may be fixed (e.g., in RAN4 RRM spec TS. 38.133), and no interruption length parameter is required. For example, the interruption length could be a fixed value for FR1 and another fixed value for FR2. In some aspects, the fixed value for FR1 is 1 milliseconds (ms) and the fixed value for FR2 is 0.75 ms.

In one aspect, the gapless measurement capability parameter and/or the interruption length parameter may be used to update previous UE capability information from act 204. An update might be needed if a capability of the UE has changed since act 204. For example, if the UE 101 is configured to communicate on a different set of frequency bands than at act 204, the UE may have a different set of spare RF resources available, and thus a different capability. Conversely, an update to the previous UE capability information from act 204 might not be necessary if the capability of the UE has not changed since act 204 (e.g., if the UE 101 is configured to communicate on the same bands as at act 204).

As shown by act 212, in some aspects, the UE 101 may perform SSB measurements on different carrier frequencies, such as frequency bands A and B, according to the measurement configuration received from the base station 111a.

Based on the configuration, the SSB measurements may be performed with or without measurement gaps. For a frequency band with gapless measurement, the UE 101 may perform an SSB measurement within a measurement gap configured to another frequency band or outside of the measurement gap with time allocated for interrupts, according to the various interruption arrangements including the corresponding interruption eligibility and length parameters disclosed in the present disclosure.

At act 214, in some aspects, a measurement report may be sent by the UE 101 to the base station 111a. The measurement report may comprise a result of the measurement.

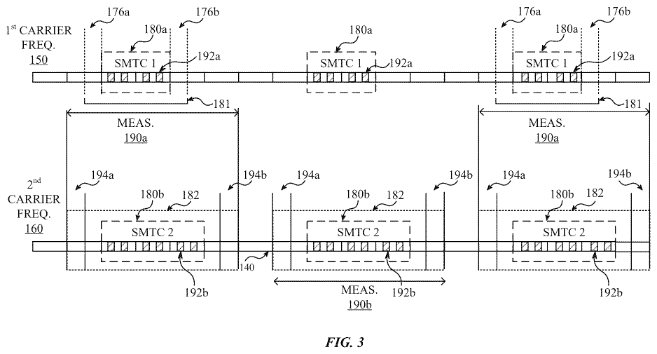

FIGS. 3-8 illustrate a radio resource management perspective of an interruption arrangement for gapless measurements in accordance with some aspects. A UE may indicate “gap” or “no gap” to a base station, and the base station may configure the UE with or without interruptions. The interruption arrangement may correspond to UE capability and network signaling as disclosed in the present disclosure. In some aspects, the UE may be the UE 101 as described with respect to other figures of the specification. The base station may be the base station 111a as described with respect to other figures of the specification.

FIGS. 3-5 are schematic diagrams illustrating scenarios when a measurement gap is configured for at least one carrier frequency, while gapless measurements are possible for one or more other carrier frequencies. Depending on a coverage of the measurement gap and the priority of the gapless measurements, SSB measurements on the one or more other carrier frequencies may be performed within the scheduled measurement gap or outside the scheduled measurement gap with additional interruptions.

FIG. 3 shows an example of a scenario when the gapless measurements can be fully covered by the measurement gap. In this example, the UE indicates ‘no-gap’ on a first carrier frequency 150 and indicates ‘gap’ on a second carrier frequency 160. As described above, this indication may be made by the UE to the base station in an RRC response and/or a UE capability information message. As an example, the carrier frequencies 150, 160 may comprise frequency bands or band combinations for a handover procedure or component carriers (CCs) for a carrier aggregation procedure. The base station schedules a first SMTC window 180a for the first carrier frequency 150 and a second SMTC window 180b for the second carrier frequency 160.

SMTC window duration and periodicity can be set to match SSB transmissions. For example, an SMTC duration can be 1, 2, 3, 4, or 5 ms. An SMTC periodicity can be 5, 10, 20, 40, 80, or 160 ms. An SMTC window may comprise one or more SSB bursts, and each SSB burst has one or multiple SSBs. The maximum number of SSBs within a burst depends on the operation band on which the SSB burst is transmitted. In one example, the first SMTC window 180a may have a 2 ms duration with 4 SSBs in a first SSB burst 192 a. The second SMTC window 180 b may have a 3 ms duration with 6 SSBs in a second SSB burst 192 b. The SMTC windows 180a, 180b may span different amounts of subframes 140 on their respective carrier frequencies. One subframe 140 may be equal to 1 ms.

In some aspects, a measurement gap 182 is configured on the second carrier frequency 160 for SSB measurements corresponding to the second SMTC window 180b. During the measurement gap 182, the UE suspends communication (Tx/Rx) with a serving cell and tunes RF modules to configured frequencies (e.g., configured MOs) and resumes connection with the serving cell after the measurement gap 182. The measurement gap 182 has a measurement gap length (MGL) greater than the second SMTC window 180b, such that the SSB burst 192b is included within the measurement gap 182, and additional time slots 194a, 194b are allocated for RF module re-tuning at the beginning and end of the measurement gap 182. For example, the MGL of the measurement gap 182 can be configured for 6 ms with the second SMTC window 180 b being 4 ms, and 0.5 ms scheduled for the additional time slots 194a, 194b.

A duration 181 may be a time period required to perform SSB measurement on the first carrier frequency, which may include the first SMTC window 180a plus interrupts 176a, 176b before and after the second SMTC window 180b that may be needed for performing the SSB measurement on the first carrier frequency even though a measurement gap is not needed for SSB measurement on the first carrier frequency. In this example, the duration 181 is temporally covered by the measurement gap 182 configured for the second SMTC window 180b. Additionally, the first SMTC window 180a is no more frequently repeated than the second SMTC window 180b. For example, the first SMTC window 180a may be repeated with a same or smaller frequency than the second SMTC window 180b. In this scenario, a first SSB measurement 190a for the first carrier frequency 150 can be performed within the measurement gap 182, and no additional interrupt is allowed outside the measurement gap 182. The UE shall switch on/off RF chain and baseband resource using the additional time slots 194a, 194b at the beginning and the end of each measurement gap occasion.

The network may not schedule the UE (e.g., suspend communication) for uplink/downlink during each occurrence of the measurement gap 182. The UE may alternate between performing the first SSB measurement 190a within the first SMTC window 180a and a second SSB measurement 190b within the second SMTC window 180b using occurrences of the measurement gap 182. For example, since the measurement gap 182 is already configured, and the duration 181 can be fully covered by the measurement gap 182, measurement 190a may be performed on the first carrier frequency 150 within first and third occurrences of the measurement gap 182. Because the measurement gap 182 has already been configured, no additional interrupts (e.g. the interrupts 176a, 176b) need to be allocated for SSB measurement, thus simplifying and preventing unnecessary waste of network scheduling.

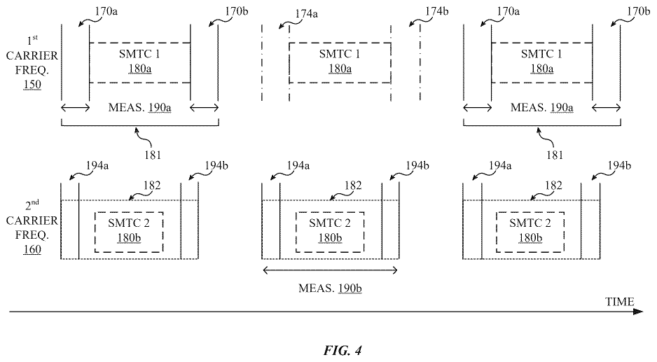

FIG. 4 shows an example of a scenario when the gapless measurements cannot be fully covered by the measurement gap. In this example, the UE still indicates ‘no-gap’ on the first carrier frequency 150 and indicates ‘gap’ on the second carrier frequency 160. The duration of the measurement gap 182 scheduled for the second SMTC window 180b cannot temporally cover the duration 181. In this example, the duration 181 includes the duration of the first SMTC window 180a plus the duration of interrupts 170a, 170b arranged respectively before and after the first SMTC window 180a.

Since the duration 181 does not fit within the bounds of the measurement gap 182, the first SSB measurement 190a needs additional time allocated outside of the measurement gap 182. Additional interrupts 170a, 170b may be scheduled before or after the first SMTC window 180a, and a portion of interrupt 170b may fall temporally outside of the measurement gap 182. During the interrupts 170a, 170b, the serving cell may suspend communication (Tx/Rx) with the UE to allow the UE to reallocate/switch RF resources, and the UE resumes connection with the serving cell after the interrupts 170a, 170b.

In this case, the UE may alternate between performing the first SSB measurement 190a within the first SMTC window 180a with the interrupts 170a, 170b and the second SSB measurement 190b within the second SMTC window 180b using the measurement gap 182. By applying gapless measurement for the first SSB measurement 190a, allocation of the measurement gap is reduced under certain conditions, and thus system throughput and mobility performance are enhanced. By allocating the interrupts 170a, 170b for the first SSB measurement 190a, interference between the first SSB measurement 190a and the serving cell communication (Tx/Rx) can be eliminated or at least reduced.

In some aspects, the UE may receive SSBs from a base station. Because the UE may alternate between performing the first SSB measurement 190a and the second SSB measurement 190b, the UE may only perform SSB measurement 190a during every other occurrence of SMTC window 180a. Although the UE may be performing the second SSB measurement 190b, the base station may not know which SMTC window the UE is measuring at a given time. To avoid conflict while the UE performs interruption, the base station may choose, at each SMTC window 180a, not to schedule the UE for uplink/downlink communications during the times at which the UE would need the interrupt times, even if the UE might be performing a measurement at SMTC window 180b and not SMTC window 180a. These dead spaces 174a, 174b. The dead spaces 174a, 174b may have the same length as the interrupts 170a, 170b. Although the interrupts are not allocated during dead spaces 174a, 174b, the base station treats it as such.

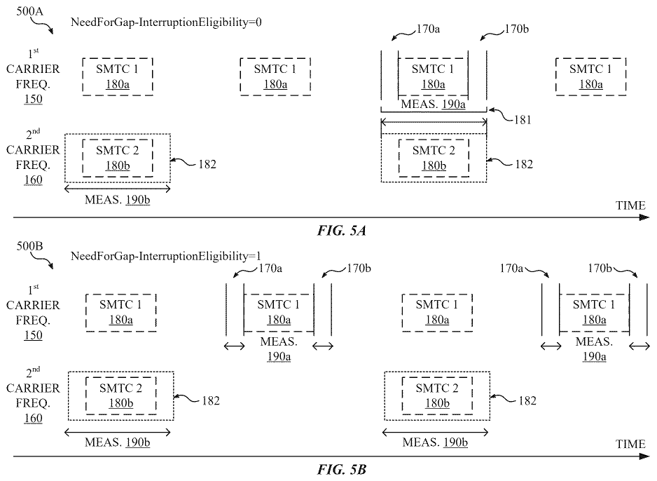

FIGS. 5A-5B show additional examples of scenarios when some of the gapless measurements are not covered by a measurement gap, while in instances where the gapless measurement do align with a corresponding measurement gap, those gapless measurements are considered as fully covered. In these examples, the UE still indicates ‘no-gap’ on the first carrier frequency 150 and ‘gap’ on the second carrier frequency 160. As shown in FIGS. 5A-5B, in some aspects, the first SMTC window 180a for the first carrier frequency 150 is more frequently repeated than the second SMTC window 180b for the second carrier frequency 160. For example, the first SMTC window 180a is repeated twice as frequently as the second SMTC window 180b as shown in the example of FIGS. 5A-5B.

In some aspects, the first SMTC window 180a may have a duration equal to or less than the second SMTC window 180b. Thus, some occurrences of the first SMTC window 180a (first and third occurrence of the first SMTC window 180a in the example of FIGS. 5A-5B) fall within the measurement gap 182 of the second carrier frequency, while the remaining occurrences of the first SMTC window 180a fall outside of the measurement gap 182 (second and fourth occurrence of the first SMTC window 180a in the example of FIGS. 5A-5B). In this case, some occurrences of the first SMTC window 180a on the first carrier frequency 150 are not covered by the measurement gap 182 configured on the second carrier frequency 160.

In this scenario, an interruption eligibility parameter (e.g., an IE NeedForGap-InterruptionEligibility) is included in network signaling indicating whether additional interruption is enabled. As discussed in this disclosure, the network signaling may be included in an RRC message such as an RRC reconfiguration or resume message. In some aspects, the interruption eligibility parameter may be based on a measurement priority. For example, the interruption eligibility parameter may be a first value indicating that the additional interruption is disabled if a measurement priority on the first carrier frequency 150 is a low priority. Conversely, the interruption eligibility parameter may be a second value indicating that the additional interruption is enabled if the measurement priority is a high priority.

As shown in FIG. 5A by an example block diagram 500A, the interruption eligibility parameter may have the first value, e.g., if measurement of the first SMTC window 180a on the first carrier frequency 150 is a low priority. In response to the interruption eligibility parameter being the first value, the UE shall perform the first SSB measurement 190a on the first carrier frequency 150 using the measurement gap 182 configured on the second carrier frequency 160 without additional interrupts configured. Since the duration 181, which includes the duration of the SMTC window 180a and the duration of the interrupts 170a, 170b, may be temporally covered by the measurement gap, SSB measurement 190a on the first carrier frequency 150 may be performed within the measurement gap 182 configured for the second carrier frequency 160.

In this case, the UE may alternate between performing the first SSB measurement 190a on the first carrier frequency 150 and the second SSB measurement 190b on the second carrier frequency 160 at each occurrence of the measurement gap 182. The first SSB measurement 190a is not performed at every occurrence of the first SMTC window 180a and only at an occurrence of the first SMTC window 180a coinciding with an occurrence of the measurement gap 182. In the example shown by the block diagram 500A, the first SSB measurement 190a may be performed on every fourth occurrence of the first SMTC window 180a (shown as performed on the third occurrence of the first SMTC window 180a in the block diagram 500A). The second SSB measurement 190b may be performed on every other occurrence of the second SMTC window 180b (shown as performed on the first occurrence of the second SMTC window 180b in the block diagram 500A). Since the measurement gap 182 is already configured for the second carrier frequency 160 and since in the instances where the measurement gap 182 aligns with the first SMTC window 180a, the measurement gap 182 fully covers the duration 181, no extra interrupts need to be scheduled and thus unnecessary waste of network scheduling is prevented.

As shown in FIG. 5B by example block diagram 500B, the interruption eligibility parameter may have the second value, e.g., if measurement of the first SMTC window 180a on the first carrier frequency 150 is a high priority, or there are large number of carriers to be measured within the measurement gap 182. In response to the interruption eligibility parameter being the second value, interrupts are allowed outside the measurement gap 182. The UE shall perform measurement 190a within the first SMTC window 180a with interrupts 170a, 170b arranged respectively before and after the first SMTC window 180a.

In this case, the UE may alternate between performing the first SSB measurement 190a on the first SMTC window 180a with the interrupts 170a, 170b and the second SSB measurement 190b on the second SMTC window 180b using the measurement gap 182. In the example shown by the block diagram 500B, the first SSB measurement 190a may be performed on every other occurrence of the first SMTC window 180a (shown as performed on the second occurrence of the first SMTC window 180a in the block diagram 500B). The second SSB measurement 190b may be performed on every occurrence of the second SMTC window 180b. By allocating the interrupts 170a, 170b for the first SSB measurement 190a, the first SSB measurement 190a and the second SSB measurement 190b may be performed more frequently, and thus measurement delay may be reduced. Further, the UE may perform high priority measurements in the first SMTC window 180a while permitted to conduct any RF switching/reallocation procedures during the interrupts 170a, 170b.

In some aspects, while performing the first SSB measurement 190a outside of the measurement gap 182, the UE may be scheduled by (e.g., return to normal uplink/downlink operation with) the base station. During the interrupt 170a, the UE may suspend communication with the base station. Since the interrupts 170a, 170b serve to avoid interference when performing RF on/off switching, after the spare RF resources are switched on during the interrupt 170a, the original RF resources used for communication with base station are free from interference. Thus, after the interrupt 170a, the UE may resume normal communication with the base station using the original set of RF resources while simultaneously performing measurement 190a using the spare RF resources. The interrupt 170b occurs after the measurement 190a is completed and the spare RF resources are switched off. The UE may suspend uplink/downlink with base station until the interrupt 170b is completed.

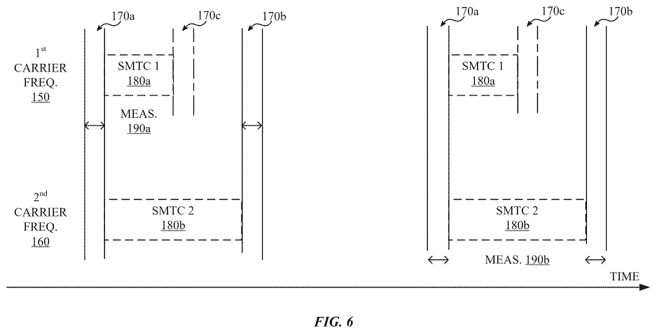

FIGS. 6-8 illustrate scenarios when no measurement gap is configured for all concerned carrier frequencies. As shown in FIG. 6, suppose the UE indicates ‘no-gap’ on the first carrier frequency 150 and also indicates ‘no-gap’ on the second carrier frequency 160. In this case, since no measurement gap is needed, the UE may perform the first SSB measurement 190a on the first carrier frequency 150 and a second SSB measurement 190b on the second carrier frequency 160 with interruptions allocated for RF on/off switching in order to reduce interference to data transmission. In one aspect, interrupt locations and the corresponding time locations when to switch on/off the RF chain and baseband resource are aligned on all the carriers even though SMTC length is different on different carriers, in order to avoid waste of network scheduling. For example, when occurrences of the first and second SMTC windows 180a, 180b temporally overlap and a duration of the second SMTC window 180b is greater than a duration of the first SMTC window 180a, a pair of interrupts 170a, 170b are allocated respectively before and after both the first and second SMTC windows 180a, 180b without additional interruptions scheduled therebetween. For example, the pair of interrupts 170a, 170b is used for the first SSB measurement 190a without a separate interrupt 170c (shown in dotted line for illustration purposes only) located after the first SMTC window 180a but before the end of the second SMTC window 180b.

Thus, the first and second SMTC windows 180a, 180b are temporally sandwiched between the pair of interrupts 170a, 170b, such that both the SMTC windows 180a, 180b fall within the bounds of the first and second interrupts 170a, 170b. In one aspect, the first interrupt 170a may occur directly before the start of first and second SMTC windows 180a, 180b as illustrated. The second interrupt 170b may occur directly after the end of second SMTC window 180b as illustrated.

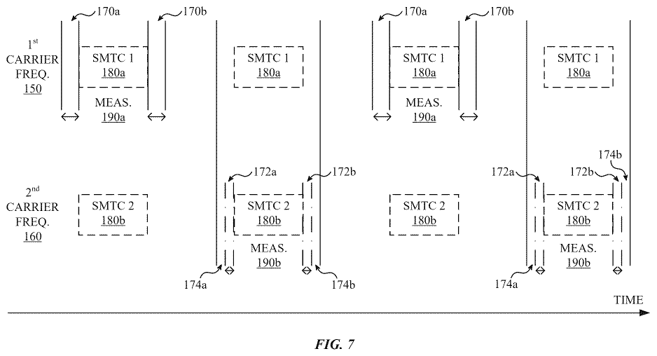

FIG. 7 illustrates an interruption arrangement for gapless UE measurements in accordance with some aspects. In this example, the UE indicates ‘no-gap’ on the first carrier frequency 150 and also indicates ‘no-gap’ on the second carrier frequency 160. Similar to the example illustrated in FIG. 6, the interrupts are aligned on the first and second carrier frequencies 150, 160. The first interrupt 170a is performed before first SMTC window 180a and the second interrupt 170b is performed after first SMTC window 180a. A third interrupt 172a is performed before a second occurrence of the second SMTC window 180b and a fourth interrupt 172b is performed after the second occurrence of the second SMTC window 180b. The first and second interrupts 170a, 170b may have a first duration, and the third and fourth interrupts 172a, 172b may have a second duration that is smaller than the first duration. The first and second durations may be indicated in an RRC message using, for example, an interruption length parameter. In some aspects, the interruption length parameter is included as part of the UE capability information or in RRC response.

In this case, the UE may perform the first SSB measurement 190a on the first SMTC window 180a with interrupts 170a, 170b. The UE may perform the second SSB measurement on the second occurrence of second SMTC window 180b with interrupts 172a, 172b. Although interrupts 172a, 172b have a smaller duration than interrupts 170a, 170b, since the network is unaware which SMTC the UE is measuring at a given time, the network may choose to schedule the UE for uplink/downlink transmission conservatively. That is, the network may assume the worst case scenario and not schedule the UE according to the greatest interruption length in order to not accidentally attempt uplink/downlink with the UE while the UE is performing an interrupt. In this case interrupts 170a, 170b have the greater duration, so the network may not schedule the UE for the duration of interrupts 170a, 170b before/after any SMTC to be measured. Although the UE performs interrupts 172a, 172b with shorter lengths with the second occurrence of second SMTC window 180b, the network is unaware, and assumes that the UE is performing the interruption with the longer duration (worst case scenario). This results in a first dead space 174a before interruption 172a and a second dead space 174b after interruption 172b. The UE is not performing an interrupt in these dead spaces, and the network is not scheduling the UE for uplink/downlink during these dead spaces, resulting in a loss of network efficiency.

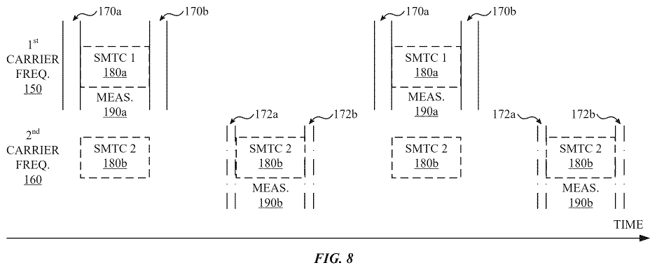

FIG. 8 illustrates an interruption arrangement for gapless UE measurements in accordance with some aspects. In this example, the UE indicates ‘no-gap’ on the first carrier frequency 150 and also indicates ‘no-gap’ on the second carrier frequency 160. Similar to the example illustrated in FIG. 6 and FIG. 7, the interrupts are aligned on the first and second carrier frequencies 150, 160. The first interrupt 170a is performed before the first SMTC window 180a and the second interrupt 170b is performed after the first SMTC window 180a. A third interrupt 172a is performed before a second occurrence of second SMTC window 180b, and a fourth interrupt 172b is performed after the second occurrence of second SMTC window 180b. The first and second interrupts 170a, 170b may have a first duration, and the third and fourth interrupts 172a, 172b may have a second duration that is smaller than the first duration.

The second SMTC window 180b on the second carrier frequency 160 may have a higher periodicity than the first SMTC window 180a on the first carrier frequency 150. For example, the first occurrence of the first SMTC window 180a may align with the first occurrence of the second SMTC window 180b. The second occurrence of the first SMTC window 180a may align with the third occurrence of second SMTC window 180b. The second occurrence of the second SMTC window 180b may be offset from the first and second occurrences of the first SMTC window 180a.

In this case, the UE may perform measurement 190a on the first occurrence of the first SMTC window 180a with interrupts 170a, 170b. The UE may perform measurement 190b on the second occurrence of the second SMTC window 180b with interrupts 172a, 172b. Since the second occurrence of the second SMTC window 180b is offset from the first SMTC window 180a, the UE only has the option to measure the second carrier frequency 160 within the second SMTC window 180b. Since the UE can only measure the second SMTC window 180b at this time, the network knows the interrupt is going to have the duration of the interrupts 172a, 172b. Since interrupts 172a, 172b have lesser durations than interrupts 170a, 170b, the network may utilize this extra time to schedule the UE for uplink/downlink, thereby improving network efficiency.

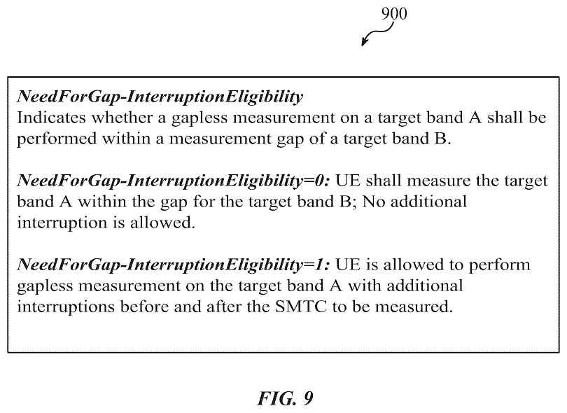

FIG. 9 illustrates possible values for the NeedForGap-InterruptionEligibility parameter. This parameter may indicate if a gapless measurement on a band which the UE indicates ‘no-gap’ (e.g., target band A) shall be performed within a configured measurement gap of a band which the UE indicates ‘gap’ (e.g., target band B). A first value may indicate the UE is to measure target band A within the measurement gap configured for target band B, with no additional interruption allowed outside of the measurement gap. In some aspects, the first value may be a value of 0 or false. A second value may indicate the UE is to measure target band A outside of the measurement gap of target band B, with an interruption before and after the SMTC window to be measured on band A. In some aspects, the second value may be a value of 1 or true.

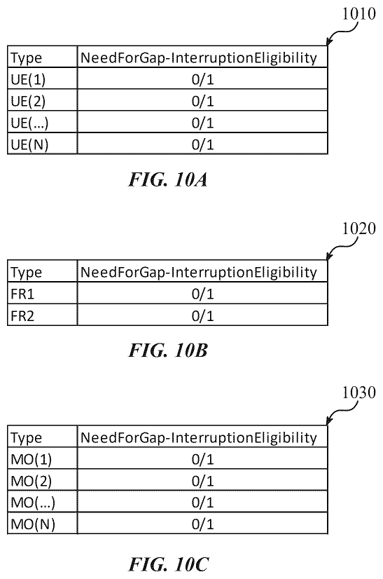

FIG. 10A-10C depict tables of interruption eligibility parameters in accordance with some aspects. As shown in a table 1010, the parameter may be assigned on a per UE basis. The network may be configured to communicate with N number of UEs, and may assign a different parameter value to be used per each UE. As shown in a table 1020, the parameter may be assigned per FR. For example, each UE may be assigned a different parameter value for FR1 and FR2 respectively by the network. Different UEs could be assigned different values for FR1 and FR2. As shown in a table 1030, the parameter may be assigned on a per MO basis. For example, each UE may be configured to measure N number of MOs and be assigned a different parameter value for each MO. Different UEs could be assigned different values for their corresponding MOs.

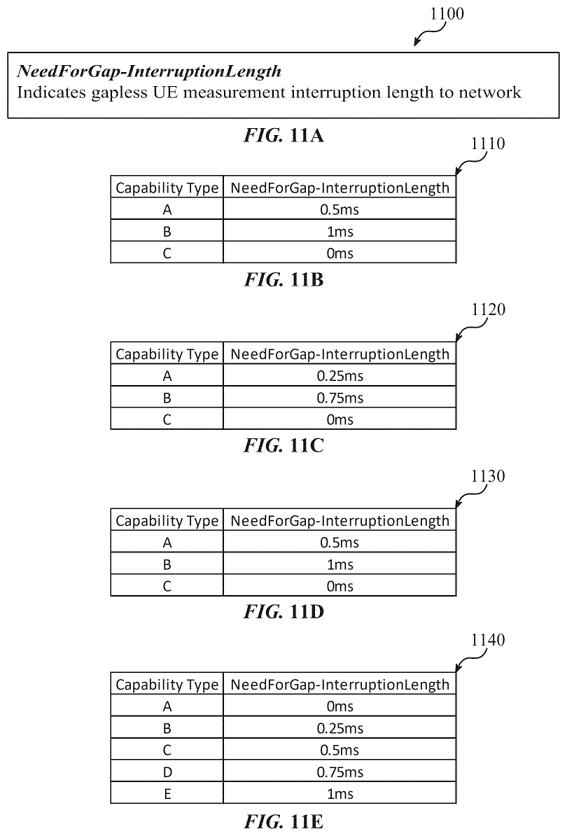

FIGS. 11A-11E depict an interruption length parameter in accordance with some aspects. In some aspects, the interruption length parameter is an IE NeedForGap-InterruptionLength. In accordance with element 1100, the interruption length parameter indicates an interruption length to be used by a UE for gapless measurement. This parameter may be indicated from the UE to a network. In some examples, the parameter is indicated in an RRC message or may be part of UE capability information.

In some aspects, the interruption length parameter is a fixed value based on a capability of the UE to measure on FR1. A capability type (e.g., type A, type B, type C, etc.) for FR1 of a UE may be fixed according to a known capability of the UE to measure on FR1. As shown in a table 1110, the interruption length parameter value varies according to the capability type for FR1. Each type may have a different interruption length parameter value. As an example, the value can be 0.5 ms for type A, 1 ms for type B, and 0 ms for type C. A value of 0 ms may correspond to no interruption.

In some aspects, the interruption length parameter is a fixed value based on a capability of a UE to measure on FR2. A capability type (e.g., type A, type B, type C, etc.) for FR2 of a UE may be fixed according to a known capability of the UE to measure on FR2. As shown in a table 1120, the interruption length parameter value varies according to the capability type for FR2. Each type may have a different interruption length parameter value. In some examples, the value may be 0.25 ms for type A, 0.75 ms for type B, and 0 ms for type C. A value of 0 ms may correspond to no interruption.

In some aspects, the interruption length parameter is a fixed value per UE. A capability type (e.g., type A, type B, type C, etc.) for a UE may be fixed according to a known capability of the UE to perform measurements. As shown in a table 1130, the interruption length parameter value varies according to the UE capability type.

Each type may have a different interruption length parameter value. In some examples, the value may be 0.5 ms for type A, 1 ms for type B, and 0 ms for type C. A value of 0 ms may correspond to no interruption.

In some aspects, the interruption length parameter is assigned on a per band basis. A capability type (e.g., type A, type B, type C, etc.) is selected by the UE based on a UE capability to measure on one or more frequency bands. In some aspects, the UE capability to measure comprises a UE capability to measure on the target band (e.g., for selecting capability type for band A, UE selects based on a capability to measure band A). In one aspect, the UE capability to measure may be based on any of the aforementioned examples, plus based on a capability of RF circuitry of the UE. The capability of the RF circuitry may depend on current available spare RF resources available to perform measurement. The spare RF resources available may depend on which bands are currently active. As shown in table 1140, in some examples, the value may be 0 ms for type A, 0.25 ms for type B, 0.5 ms for type C, 0.75 ms for type D, and 1 ms for type E.

Although explicit values are given, these values are merely examples. It is appreciated that other values fall within the scope of this disclosure, and that these values may vary according to UE capability or network capability.

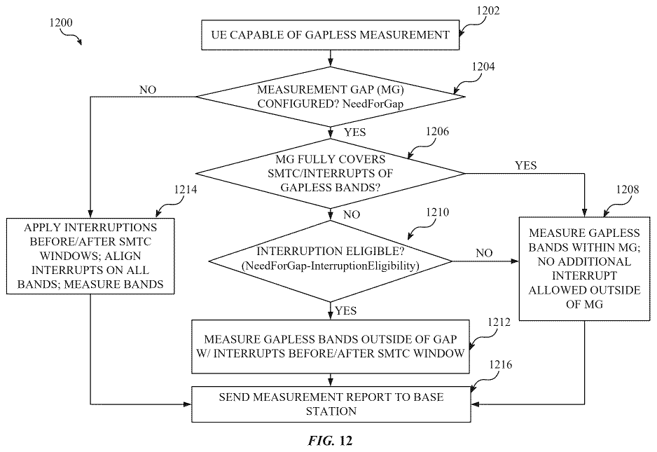

FIG. 12 depicts a block diagram 1200 of a method for performing gapless UE measurements in accordance with some aspects. In some aspects, a UE is configured with a gapless measurement on at least one carrier frequency, such as a frequency band or band combination. Depending on various conditions, the base station may configure the UE with or without interruptions on a certain carrier frequency. Such conditions may include whether a measurement gap is configured on at least one other carrier frequency, whether the measurement gap fully covers an SMTC window of the gapless measurement, and interruption eligibility (e.g., whether interruptions are allowed). The interruption arrangement may correspond to UE capability and network signaling as disclosed in the present disclosure. In some aspects, a measurement gap configuration may be determined in accordance with the examples given in any one of FIGS. 3-8. The UE may be the UE 101 as described with respect to other figures of the specification. The base station may be the base station 111a as described with respect to other figures of the specification.

As shown by act 1202, the UE may indicate its capability of gapless measurement to a base station through RRC signaling. The UE may indicate its capability of gapless measurement (“gap” or “no gap”) on each concerned frequency band. In one aspect, a UE is capable of a gapless measurement on at least one frequency band or band combination.

As shown by act 1204, UE measurement configuration is determined based on whether a measurement gap is configured on at least one concerned band. In some examples, as shown by act 1214, if the UE indicates ‘no-gap’ on all concerned bands, such as band A and band B, then the measurement is performed with interrupts before and after each SMTC to be measured. FIGS. 6-8 provide non-limiting examples. In some aspects, one pair of interrupts is shared by multiple bands. The pair of interrupts may be arranged before and after an SMTC window of the multiple bands with a longer duration.

Alternatively, as shown by act 1206, if the UE indicates ‘no-gap’ on some bands (e.g., band A) but ‘gap’ on other bands (e.g., band B) with a measurement gap configured, then UE measurement configuration may be determined also based on whether the SMTC windows and the corresponding interrupts on the gapless bands (e.g., band A) can be fully covered by the measurement gap. As shown by act 1208, if the SMTC windows and corresponding interrupts on the gapless bands (e.g., band A) can be fully covered by the measurement gap, the measurement is performed on band A within the measurement gap. No additional interrupt is allowed outside the measurement gap. FIG. 3 provides a non-limiting example.

Alternatively, as shown by act 1210, if the SMTC windows and the corresponding interrupts on gapless bands (e.g., band A) cannot be fully covered by the measurement gap, network signaling is introduced. In some aspects the introduced network signaling may comprise an RRC IE NeedForGap-InterruptionEligibility. Based on the value of NeedForGap-InterruptionEligibility, the UE may choose how to measure. For example, as shown by act 1208, if the value of NeedForGap-InterruptionEligibility is a first value indicating no additional interruption is allowed, the UE may measure on the gapless bands (e.g., band A)within the gap, with no additional interruption allowed outside the gap. As shown by act 1212, if the value of NeedForGap-InterruptionEligibility is a second value indicating additional interruption is allowed, the UE may measure on the gapless bands (e.g., band A) with the corresponding interrupts allocated before and after each SMTC window. The SMTC window and/or the corresponding interrupts may be located outside of the measurement gap. FIGS. 4 and 5 provide non-limiting examples. Finally, as shown by act 1216, a measurement report is sent to the base station.

In aspects, the CN 120 can be a 5GC (referred to as “5GC 120” or the like), and the RAN 110 can be connected with the CN 120 via two parts, a Next Generation (NG) user plane (NG-U) interface 114, which carries traffic data between the RAN nodes and a User Plane Function (UPF), and the S1 control plane (NG-C) interface 115, which is a signaling interface between the RAN nodes and Access and Mobility Management Functions (AMFs).

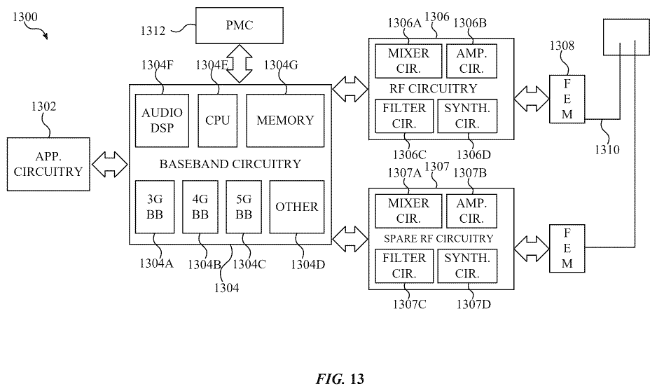

FIG. 13 is a diagram illustrating example components of a device 1300 that can be employed in accordance with some aspects of the present disclosure. In some aspects, the device 1300 can include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 can be included in a UE or a RAN node such as the UE 101 or the BS 111 as described, for example, with reference to FIGS. 1-2 and throughout the present disclosure. The UE 101 may be configured to perform gapless measurements, as described throughout the present disclosure. In some implementations, the device 1300 can include fewer elements (e.g., a RAN node may not utilize application circuitry 1302 and instead include a processor/controller to process IP data received from a CN, which may be a 5GC or an Evolved Packet Core (EPC)). In some implementations, the device 1300 can include additional elements such as, for example, memory/storage, display, camera, sensor (including one or more temperature sensors, such as a single temperature sensor, a plurality of temperature sensors at different locations in device 1300, etc.), or input/output (I/O) interface. In other implementations, the components described below can be included in more than one device (e.g., said circuitries can be separately included in more than one device for Cloud-RAN (C-RAN) implementations).

The application circuitry 1302 can include one or more application processors. For example, the application circuitry 1302 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1300. In some implementations, processors of application circuitry 1302 can process IP data packets received from an EPC.

The baseband circuitry 1304 can include circuitry such as, but not limited to, one or more single-core or multi-core processors. The baseband circuitry 1304 can include one or more baseband processors or control logic to process baseband signals received from a receive signal path of the RF circuitry 1306 and to generate baseband signals for a transmit signal path of the RF circuitry 1306. Baseband circuitry 1304 can interface with the application circuitry 1302 for generation and processing of the baseband signals and for controlling operations of the RF circuitry 1306. For example, in some implementations, the baseband circuitry 1304 can include a 3G baseband processor 1304A, a 4G baseband processor 1304B, a 5G baseband processor 1304C, or other baseband processor(s) 1304D for other existing generations, generations in development or to be developed in the future (e.g., 2G, 6G, etc.).

The baseband circuitry 1304 (e.g., one or more of baseband processors 1304A-D) can handle various radio control functions that enable communication with one or more radio networks via the RF circuitry 1306. In other implementations, some or all of the functionality of baseband processors 1304A-D can be included in modules stored in the memory 1304G and executed via a Central Processing Unit (CPU) 1304E. The radio control functions can include, but are not limited to, signal modulation/demodulation, encoding/decoding, radio frequency shifting, etc. In some implementations, the baseband circuitry 1304 can include one or more audio digital signal processor(s) (DSP) 1304F.

RF circuitry 1306 can enable communication with wireless networks using modulated electromagnetic radiation through a non-solid medium. In various implementations, the RF circuitry 1306 can include switches, filters, amplifiers, etc. to facilitate the communication with the wireless network. RF circuitry 1306 can include a receive signal path which can include circuitry to down-convert RF signals received from the FEM circuitry 1308 and provide baseband signals to the baseband circuitry 1304. RF circuitry 1306 can also include a transmit signal path which can include circuitry to up-convert baseband signals provided by the baseband circuitry 1304 and provide RF output signals to the FEM circuitry 1308 for transmission.

In some implementations, the receive signal path of the RF circuitry 1306 can include mixer circuitry 1306A, amplifier circuitry 1306B and filter circuitry 1306C. In some implementations, the transmit signal path of the RF circuitry 1306 can include filter circuitry 1306C and mixer circuitry 1306A. RF circuitry 1306 can also include synthesizer circuitry 1306D for synthesizing a frequency for use by the mixer circuitry 1306A of the receive signal path and the transmit signal path.

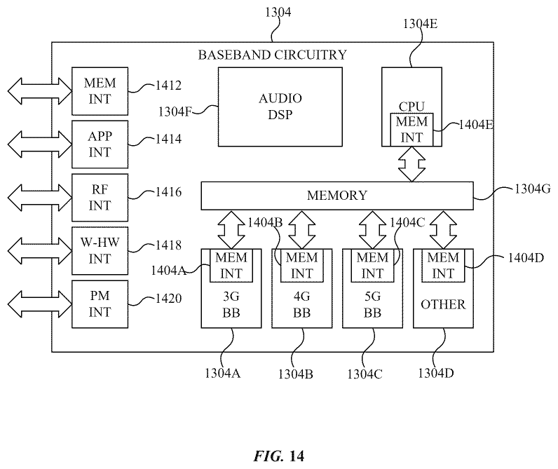

FIG. 14 illustrates a diagram illustrating example interfaces of baseband circuitry that can be employed in accordance with some aspects. As discussed above, the baseband circuitry 1304 of FIG. 13 can comprise processors 1304A-1304E and a memory 1304G utilized by said processors. Each of the processors 1304A-1304E can include a respective memory interface 1404A-1404E to send/receive data to/from the memory 1304G.

The baseband circuitry 1304 can further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312).

Examples herein can include subject matter such as a method, means for performing acts or blocks of the method, at least one machine-readable medium including executable instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to implementations and examples described.

In one example, suppose the UE is capable of gapless measurement on the first carrier frequency and needs a measurement gap for the second carrier frequency. Further suppose the first SMTC window for the first carrier frequency is not fully covered by the measurement gap for the second carrier frequency. In this example, whether to allocate additional interrupts may be based on network signaling. The UE may receive an interruption eligibility parameter (e.g., a parameter in an information element of measurement configuration, ‘NeedForGap-InterruptionEligibility’) from a base station to indicate whether the UE shall perform the first SSB measurement on the first carrier frequency within the measurement gap allocated for the second carrier frequency. A first value for NeedForGap-InterruptionEligibility may indicate the UE to perform the first SSB measurement within the measurement gap with no additional interruption allowed outside the measurement gap. A second value for NeedForGap-InterruptionEligibility may indicate the UE to perform the first SSB measurement outside the measurement gap with interrupts before and after the first SMTC window. By introducing the interruption eligibility parameter, the base station can schedule the gapless SSB measurement flexibly based on the application needs. Gapless measurements can be scheduled outside the measurement gap to reduce measurement delay if the SSB measurement has a high priority, or there is a large number of carriers to be measured within the measurement gap. The NeedForGap-InterruptionEligibility parameter may be indicated per MO, per Carrier frequency 1 (FR1)/Carrier frequency 2 (FR2), or per UE. FR1, as described herein, may refer to a radio carrier frequency of 410 MHz to 7.125GHz. FR2, as described herein, may refer to a radio carrier frequency of 24.25 GHz to 52.6 GHZ

In another example, suppose the UE is capable of gapless measurement on both a first carrier frequency and a second carrier frequency. An SMTC window on the first carrier frequency may have a duration greater than an SMTC window on the second carrier frequency. In this example, the UE shall perform the first measurement on the first carrier frequency with a pair of interrupts. The pair of interrupts may be arranged respectively before and after the SMTC window on the first carrier frequency. The UE shall perform the second measurement on the second carrier frequency with the same pair of interrupts, such that the interrupts are aligned on all carriers.

A base station may not have knowledge which carrier frequency a UE is measuring on at a given time. By aligning the interrupts on all carriers, the base station does not need to know which carrier frequency the UE is measuring on in order to optimize performance. The base station is able to maximize UE uplink/downlink scheduling since it minimizes the number of occurrences where the UE might be busy performing an interrupt. Since the interrupts are aligned on all carriers, the location of the interrupt being performed does not depend on which carrier frequency the UE is measuring on.

If interruption is to be allocated, an interruption length needs to be specified. In some aspects, the UE may communicate an interruption length to be used to the network via an interruption length parameter (e.g., a parameter in an information element of UE capability, ‘NeedForGap-InterruptionLength’). In one aspect, this interruption length can be a fixed value assigned on a per UE basis. In another aspect, this value could be a fixed value for FR1 and another fixed value for FR2. These values could be predetermined for the UE and be based on a capability of the UE to measure on FR1 and FR2. In another aspect, this value could be assigned on a per frequency band basis. The UE could choose a value based on the UE's capability to measure on one or more frequency bands. In some aspects, the capability to measure on the one or more frequency bands may be based on the spare RF circuitry of the UE. In some aspects, the capability to measure on the one or more frequency bands may be based on the active bands being used by other cells (e.g., a serving base station).

### ADDITIONAL EXAMPLES

Examples herein can include subject matter such as a method, means for performing acts or blocks of the method, at least one machine-readable medium including executable instructions that, when performed by a machine (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to aspects and examples described.

Example 1 is an apparatus for a User Equipment (UE) comprising one or more processors. The one or more processors are configured to receive network configuration information from a serving cell, the network information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, transmit UE capability information to the serving cell, the UE capability information comprising a first gapless measurement capability parameter for measurement on the first carrier frequency and a second gapless measurement capability parameter for measurement on the second carrier frequency, wherein the first gapless measurement capability parameter indicates that the UE is capable of gapless measurement on the first carrier frequency, and wherein the second gapless measurement capability parameter indicates that the UE needs a measurement gap for measurement on the second carrier frequency, and perform a first synchronization signal block (SSB) measurement on the first carrier frequency within a first occurrence of the measurement gap and a second SSB measurement on the second carrier frequency within a second occurrence of the measurement gap.

Example 2 comprises the subject matter of any variation of example 1, wherein the measurement gap temporally covers the first SMTC window and the second SMTC window.

Example 3 is an apparatus for a User Equipment (UE), comprising one or more processors. The one or more processors are configured to receive network configuration information from a serving cell, the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, transmit UE capability information to the serving cell, the UE capability information comprising a first gapless measurement capability parameter for measurement on the first carrier frequency and a second gapless measurement capability parameter for measurement on the second carrier frequency, wherein the first gapless measurement capability parameter indicates that the UE is capable of gapless measurement on the first carrier frequency, and wherein the second gapless measurement capability parameter indicates that the UE needs a measurement gap for measurement on the second carrier frequency, receive an interruption eligibility parameter indicating whether additional interruption is allocated outside the measurement gap, in response to the interruption eligibility parameter being a first value, performing a first synchronization signal block (SSB) measurement on the first carrier frequency only within the measurement gap, and in response to the interruption eligibility parameter being a second value, performing the first SSB measurement outside the measurement gap with a first interruption arranged before the first SMTC window and a second interruption arranged after the first SMTC window.

Example 4 comprises the subject matter of any variation of example 3, wherein the interruption eligibility parameter is the second value if a portion of the first SMTC window is temporally located outside of the measurement gap.

Example 5 comprises the subject matter of any variation of example 3, wherein the interruption eligibility parameter is the second value, and wherein the UE capability information further comprises an interruption length parameter indicating a length of the first interruption or the second interruption.

Example 6 comprises the subject matter of any variation of example 5, wherein the interruption length parameter is fixed per UE.

Example 7 comprises the subject matter of any variation of example 5, wherein the interruption length parameter is fixed per frequency range 1 (FR1) and per frequency range 2 (FR2).

Example 8 comprises the subject matter of any variation of example 5, wherein the interruption length parameter is indicated per band based on a UE capability to measure one or more bands.

Example 9 comprises the subject matter of any variation of example 3, wherein a length of the first interruption or the second interruption is pre-determined per UE.

Example 10 comprises the subject matter of any variation of example 3, wherein a length of the first interruption or the second interruption is pre-determined per frequency range 1 (FR1) and per frequency range 2 (FR2).

Example 11 is an apparatus for a User Equipment (UE) comprising one or more processors. The one or more processors are configured to receive network configuration information from a serving cell, the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, transmit UE capability information to the serving cell, the UE capability information comprising a first gapless measurement capability parameter for measurement on the first carrier frequency and a second gapless measurement capability parameter for measurement on the second carrier frequency, wherein the first and second gapless measurement capability parameters indicate that the UE is capable of gapless measurement respectively on the first and second carrier frequencies, and perform a first synchronization signal block (SSB) measurement on the first carrier frequency and a second SSB measurement on the second carrier frequency with a first interruption before both the first SMTC window and the second SMTC window and a second interruption after both the first SMTC window and the second SMTC window.

Example 12 comprises the subject matter of any variation of example 11, wherein the UE capability information further comprises an interruption length parameter indicating a length of the first interruption or the second interruption.

Example 13 comprises the subject matter of any variation of example 12, wherein the interruption length parameter is fixed per UE.

Example 14 comprises the subject matter of any variation of example 12, wherein the interruption length parameter is fixed per frequency range 1 (FR1) and per frequency range 2 (FR2).

Example 15 comprises the subject matter of any variation of example 12, wherein the interruption length parameter is indicated per band based on a UE capability to measure one or more bands.

Example 16 comprises the subject matter of any variation of example 11, wherein a length of the first interruption or the second interruption is pre-determined per UE, is or pre-determined per frequency range 1 (FR1) and per frequency range 2 (FR2).

Example 17 is an apparatus for a User Equipment (UE) comprising one or more processors. The one or more processors are configured to receive network configuration information from a serving cell, the network configuration information comprising a first synchronization signal (SS)/physical broadcast channel (PBCH) measurement timing configuration (SMTC) defining a first SMTC window allocated to a first carrier frequency, transmit UE capability information to the serving cell, the UE capability information comprising a first gapless measurement capability parameter for measurement on the first carrier frequency, wherein the first gapless measurement capability parameter indicates that the UE is capable of gapless measurement on the first carrier frequency, and perform a first synchronization signal block (SSB) measurement within the first SMTC window. The first SSB measurement is performed with a first interruption arranged before the first SMTC window and a second interruption arranged after the first SMTC window, and the UE capability information further comprises an interruption length parameter indicating a length of the first interruption or the second interruption.

Example 18 comprises the subject matter of any variation of example 17, wherein the interruption length parameter is fixed per UE.

Example 19 comprises the subject matter of any variation of example 17, wherein the interruption length parameter is fixed per frequency range 1 (FR1) and per frequency range 2 (FR2).

Example 20 comprises the subject matter of any variation of example 17, wherein the interruption length parameter is indicated per band based on a UE capability to measure one or more bands.

Example 21 comprises the subject matter of any variation of example 17, wherein the network configuration information further comprises a second SMTC defining a second SMTC window allocated to a second carrier frequency, wherein the UE capability information comprises a second gapless measurement capability parameter for the second carrier frequency, and wherein the one or more processors are further configured to perform a second SSB measurement within the second SMTC window.

Example 22 comprises the subject matter of any variation of example 21, wherein the second gapless measurement capability parameter indicates that the UE is capable of gapless measurement on the second carrier frequency, and wherein the first interruption is arranged before both the first SMTC window and the second SMTC window and the second interruption is arranged after both the first SMTC window and the second SMTC window.

Example 23 comprises the subject matter of any variation of example 21, wherein the second gapless measurement capability parameter indicates that the UE needs a measurement gap for the second carrier frequency, and wherein the one or more processors are further configured to receive an interruption eligibility parameter indicating that the first interruption and the second interruption are allocated outside the measurement gap.

Example 24 comprises the subject matter of any variation of example 23, wherein the interruption eligibility parameter is indicated per measurement object (MO).

Example 25 comprises the subject matter of any variation of example 23, wherein the interruption eligibility parameter is indicated for frequency range 1 (FR1) and frequency range 2 (FR2).

Example 26 comprises the subject matter of any variation of example 23, wherein the interruption eligibility parameter is indicated per UE.

Example 27 is an apparatus for a User Equipment (UE) comprising one or more processors. The one or more processors are configured to receive network configuration information from a serving cell, the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, transmit UE capability information to the serving cell, the UE capability information comprising a first gapless measurement capability parameter for the first carrier frequency and a second gapless measurement capability parameter for the second carrier frequency, wherein the first gapless measurement capability parameter indicates that the UE is capable of gapless measurement on the first carrier frequency, and perform a first synchronization signal block (SSB) measurement within the first SMTC window and a second SSB measurement within the second SMTC window.

Example 28 comprises the subject matter of any variation of example 27, wherein the one or more processors are further configured to perform the first SSB measurement within a measurement gap without additional interruption, if the second gapless measurement capability parameter indicates that the UE needs the measurement gap for measurement on the second carrier frequency, and further if the first SMTC window is fully covered by the measurement gap.

Example 29 comprises the subject matter of any variation of examples 27-28, wherein the one or more processors are further configured to receive an interruption eligibility parameter indicating whether additional interruptions are allocated outside the measurement gap, if the second gapless measurement capability parameter indicates that the UE needs the measurement gap for measurement on the second carrier frequency, and further if a portion of the first SMTC window is temporally located outside of the measurement gap, perform the first SSB measurement within the measurement gap without additional interruption, if the interruption eligibility parameter for the first carrier frequency is a first value indicating that additional interruption is not allocated outside the measurement gap, and perform the first SSB measurement with a first interruption before the first SMTC window and a second interruption after the first SMTC window, if the interruption eligibility parameter for the first carrier frequency is a second value indicating that additional interruption is allocated outside the measurement gap.

Example 30 comprises the subject matter of any variation of examples 27-29, wherein the one or more processors are further configured to perform the first SSB measurement and the second SSB measurement with a first interruption before both the first SMTC window and the second SMTC window and a second interruption after both the first SMTC window and the second SMTC window, if the second gapless measurement capability parameter indicates that the UE is capable of gapless measurement on the second carrier frequency.

Example 31 comprises the subject matter of any variation of example 30, wherein a length of the first interruption or the second interruption is fixed or pre-determined per UE, per frequency range 1 (FR1), or per frequency range 2 (FR2).

Example 32 comprises the subject matter of any variation of example 30, wherein a length of the first interruption or the second interruption is determined per band based on a UE capability to measure one or more bands.

Example 33 is an apparatus for a Base Station (BS) comprising one or more processors. The one or more processors are configured to transmit network configuration information to a user equipment (UE), the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, receive UE capability information, the UE capability information comprising a first gapless measurement capability parameter for the first carrier frequency and a second gapless measurement capability parameter for the second carrier frequency, wherein the first gapless measurement capability parameter indicates that the UE is capable of gapless measurement on the first carrier frequency, and wherein the second gapless measurement capability parameter indicates that the UE needs a measurement gap for measurement on the second carrier frequency, transmit an interruption eligibility parameter to the UE, the interruption eligibility parameter indicating whether additional interruption is allocated outside the measurement gap, configure the UE to perform a first synchronization signal block (SSB) measurement only within the measurement gap on the first carrier frequency if the interruption eligibility parameter is a first value, and configure the UE to perform the first SSB measurement outside the measurement gap with a first interruption arranged before the first SMTC window and a second interruption arranged after the first SMTC window if the interruption eligibility parameter is second value.

Example 34 comprises the subject matter of any variation of example 33, wherein the one or more processors are configured to suspend downlink or uplink communication with the UE during the first and second interruptions.

Example 35 comprises the subject matter of any variation of example 33, wherein the interruption eligibility parameter is based on a priority of the first SSB measurement.

Example 36 comprises the subject matter of any variation of example 33, wherein the interruption eligibility parameter is the second value, and wherein the UE capability information further comprises an interruption length parameter indicating a length of the first interruption or the second interruption.

Example 37 comprises the subject matter of any variation of example 36, wherein the interruption length parameter is fixed per UE.

Example 38 comprises the subject matter of any variation of example 36, wherein the interruption length parameter is fixed per frequency range 1 (FR1) and per frequency range 2 (FR2).

Example 39 comprises the subject matter of any variation of example 36, wherein the interruption length parameter is indicated per band based on a UE capability to measure one or more bands.

Example 40 comprises the subject matter of any variation of example 33, wherein a length of the first interruption or the second interruption is pre-determined per UE, or is pre-determined per frequency range 1 (FR1) and per frequency range 2 (FR2).

Example 41 is a method to be implemented by a User Equipment (UE). The method comprises: receiving network configuration information from a serving cell, the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, transmitting UE capability information to the serving cell, the UE capability information comprising a first gapless measurement capability parameter for the first carrier frequency and a second gapless measurement capability parameter for the second carrier frequency, wherein the first gapless measurement capability parameter indicates that the UE is capable of gapless measurement on the first carrier frequency, and wherein the second gapless measurement capability parameter indicates that the UE needs a measurement gap for measurement on the second carrier frequency, receiving an interruption eligibility parameter indicating whether additional interruption is allowed outside the measurement gap, in response to the interruption eligibility parameter being a first value, performing a first synchronization signal block (SSB) measurement on the first carrier frequency only within the measurement gap, and in response to the interruption eligibility parameter being a second value, performing the first SSB measurement on the first carrier frequency outside the measurement gap with a first interruption arranged before the first SMTC window and a second interruption arranged after the first SMTC window.

Example 42 comprises the subject matter of any variation of example 41, wherein the interruption eligibility parameter is the second value, and wherein the UE capability information further comprises an interruption length parameter indicating a length of the first interruption or the second interruption.

Example 43 comprises the subject matter of any variation of example 42, wherein the interruption length parameter is fixed per UE.

Example 44 comprises the subject matter of any variation of example 42, wherein the interruption length parameter is fixed per frequency range 1 (FR1) and per frequency range 2 (FR2).

Example 45 comprises the subject matter of any variation of example 42, wherein the interruption length parameter is indicated per band based on a UE capability to measure one or more bands.

Example 46 comprises the subject matter of any variation of example 41, wherein a length of the first interruption or the second interruption is pre-determined per UE, or is pre-determined per frequency range 1 (FR1) and per frequency range 2 (FR2).

Example 47 comprises an apparatus for a User Equipment (UE) comprising one or more processors. The one or more processors are configured to: receive network configuration information from a serving cell, the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, transmit UE capability information to the serving cell, the UE capability information comprising a first gapless measurement capability parameter for the first carrier frequency and a second gapless measurement capability parameter for the second carrier frequency, wherein the first gapless measurement capability parameter indicates that the UE is capable of gapless measurement on the first carrier frequency, and perform a first synchronization signal block (SSB) measurement on the first carrier frequency and a second SSB measurement on the second carrier frequency based on an alignment of the first and second SMTC windows.

Example 48 comprises the subject matter of any variation of example 47, wherein the second gapless measurement capability parameter indicates that the UE needs a measurement gap for measurement on the second carrier frequency, wherein the first SSB measurement is performed within a first occurrence of the measurement gap, and wherein the second SSB measurement is performed within a second occurrence of the measurement gap.

Example 49 comprises the subject matter of any variation of example 48, wherein the measurement gap temporally covers the first SMTC window and its corresponding interrupts, and wherein the measurement gap temporally covers the second SMTC window.

Example 50 comprises the subject matter of any variation of example 47, wherein the second gapless measurement capability parameter indicates that the UE needs a measurement gap for measurement on the second carrier frequency, and wherein the one or more processors are further configured to: receive an interruption eligibility parameter indicating whether additional interruption is allocated outside of the measurement gap, in response to the interruption eligibility parameter being a first value, performing the first SSB measurement on the first carrier frequency only within the measurement gap, in response to the interruption eligibility parameter being a second value, performing the first SSB measurement with a first interruption arranged before the first SMTC window and a second interruption arranged after the first SMTC window, wherein a portion of the first interruption, a portion of the first SMTC window, or a portion of the second interruption falls temporally outside of the measurement gap.

Example 51 comprises the subject matter of any variation of example 50, wherein a portion of the first SMTC window, or a portion of the second interruption falls temporally within the measurement gap.

Example 52 comprises the subject matter of any variation of example 50, wherein the interruption eligibility parameter is the second value, and wherein the UE capability information further comprises an interruption length parameter indicating a length of the first interruption or the second interruption.

Example 53 comprises the subject matter of any variation of example 52, wherein the interruption length parameter is fixed per UE.

Example 54 comprises the subject matter of any variation of example 52, wherein the interruption length parameter is fixed per frequency range 1 (FR1) and per frequency range 2 (FR2).

Example 55 comprises the subject matter of any variation of example 52, wherein the interruption length parameter is indicated per band based on a UE capability to measure one or more bands.

Example 56 comprises the subject matter of any variation of example 50, wherein a length of the first interruption or the second interruption is pre-determined per UE.

Example 57 comprises the subject matter of any variation of example 50, wherein a length of the first interruption or the second interruption is pre-determined per frequency range 1 (FR1) and per frequency range 2 (FR2).

Example 58 comprises the subject matter of any variation of example 47, wherein the second gapless measurement capability parameters indicates that the UE is capable of gapless measurement on the second carrier frequency, and wherein the one or more processors are further configured to: perform the first SSB measurement on the first carrier frequency and the second SSB measurement on the second carrier frequency with a first interruption before both the first SMTC window and the second SMTC window and a second interruption after both the first SMTC window and the second SMTC window.

Example 59 comprises the subject matter of any variation of example 58, wherein the UE capability information further comprises an interruption length parameter indicating a length of the first interruption or the second interruption.

Example 60 is an apparatus for a base station comprising one or more processors. The one or more processors are configured to: transmit network configuration information to a user equipment (UE), the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, receive UE capability information, the UE capability information comprising a first gapless measurement capability parameter for the first carrier frequency and a second gapless measurement capability parameter for the second carrier frequency, wherein the first gapless measurement capability parameter indicates that the UE is capable of gapless measurement on the first carrier frequency, and configure the UE to perform a first synchronization signal block (SSB) measurement and a second SSB measurement based on an alignment of the first and second SMTC windows.

Example 61 comprises the subject matter of any variation of example 60, wherein the second gapless measurement capability parameter indicates that the UE needs a measurement gap for measurement on the second carrier frequency, and wherein the one or more processors are further configured to: transmit an interruption eligibility parameter to the UE, the interruption eligibility parameter indicating whether additional interruption is allocated outside the measurement gap, configure the UE to perform the first SSB measurement only within the measurement gap on the first carrier frequency if the interruption eligibility parameter is a first value, configure the UE to perform the first SSB measurement with a first interruption arranged before the first SMTC window and a second interruption arranged after the first SMTC window if the interruption eligibility parameter is second value, wherein a portion of the first interrupt, a portion of the first SMTC window, or a portion of the second interrupt falls temporally outside of the measurement gap.

Example 62 comprises the subject matter of any variation of example 61, wherein the one or more processors are configured to suspend downlink or uplink communication with the UE during the first and second interruptions.

Example 63 comprises the subject matter of any variation of example 61, wherein the interruption eligibility parameter is based on a priority of the first SSB measurement.

Example 64 is a method to be implemented by a User Equipment (UE). The method comprises: receiving network configuration information from a serving cell, the network configuration information comprising a first synchronization signal (SS)/physical broadcast channel (PBCH) measurement timing configuration (SMTC) defining a first SMTC window allocated to a first carrier frequency, and further comprising a second SMTC defining a second SMTC window allocated to a second carrier frequency, transmitting UE capability information to the serving cell, the UE capability information comprising a first gapless measurement capability parameter for the first carrier frequency and a second gapless measurement capability parameter for the second carrier frequency, wherein the first gapless measurement capability parameter indicates that the UE is capable of gapless measurement on the first carrier frequency, and performing a first synchronization signal block (SSB) measurement on the first carrier frequency and a second SSB measurement on the second carrier frequency based on an alignment of the first and second SMTC windows.

Example 65 comprises the subject matter of any variation of example 64, wherein the second gapless measurement capability parameter indicates that the UE needs a measurement gap for measurement on the second carrier frequency, wherein the first SSB measurement is performed within a first occurrence of the measurement gap, and wherein the second SSB measurement is performed within a second occurrence of the measurement gap.

Example 66 comprises the subject matter of any variation of example 65, wherein the measurement gap temporally covers the first SMTC window and its corresponding interrupts, and wherein the measurement gap temporally covers the second SMTC window.

The above description of illustrated examples, implementations, aspects, etc., of the subject disclosure, including what is described in the Abstract, is not intended to be exhaustive or to limit the disclosed aspects to the precise forms disclosed.

While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. A baseband processor configured to, when executing instructions stored in a memory, perform operations comprising:
receiving a radio resource control (RRC) message including a first interruption parameter indicating whether a user equipment (UE) is eligible to use interruptions for a gapless measurement;
providing, to a radio frequency (RF) interface for transmission, an RRC response message including a second interruption parameter indicating whether interruption is to be used by the UE for the gapless measurement; and
performing the gapless measurement on a frequency band without a measurement gap, based on the first and second interruption parameters.

22. The baseband processor of claim 21, wherein second interruption parameter comprises an interruption length parameter indicating a length of interruption to be used to perform the gapless measurement, wherein a value of 0 milliseconds (ms) for the interruption length parameter corresponds to no interruption.

23. The baseband processor of claim 21, wherein the operations further comprise:
performing the gapless measurement with a fixed interruption length based on whether the gapless measurement is on a frequency range 1 (FR1) or a frequency range 2 (FR2).

24. The baseband processor of claim 21, wherein the RRC message comprises an RRC reconfiguration message or an RRC resume message, and wherein the RRC response message is provided in response to the RRC reconfiguration message or the RRC resume message.

25. The baseband processor of claim 21, wherein the operations further comprise:
providing, to the RF interface for transmission, UE capability information including a gapless measurement capability parameter indicating that the UE is capable of performing the gapless measurement on the frequency band; and
performing the gapless measurement on the frequency band based on the first and second interruption parameters.

26. The baseband processor of claim 21, wherein the first interruption parameter indicates whether the UE is eligible to use interruptions for the gapless measurement based on a priority of the gapless measurement.

27. The baseband processor of claim 21, wherein the operations further comprise:
providing the second interruption parameter based on whether a measurement gap fully covers the gapless measurement, wherein the measurement gap and the gapless measurement are on different frequency bands.

28. A baseband processor configured to, when executing instructions stored in a memory, perform operations comprising:
providing, to a radio frequency (RF) interface for transmission, a radio resource control message including a first interruption parameter indicating whether a user equipment (UE) is eligible to use interruptions for a gapless measurement on a frequency band without a measurement gap;
receiving an RRC response message including a second interruption parameter indicating whether interruption is to be used by the UE for the gapless measurement; and receiving a measurement report based on the first and second interruption parameters.

29. The baseband processor of claim 28, wherein second interruption parameter comprises an interruption length parameter indicating a length of interruption to be used by the UE to perform the gapless measurement, wherein a value of 0 milliseconds (ms) for the interruption length parameter corresponds to no interruption.

30. The baseband processor of claim 28, wherein a length of interruption for the gapless measurement is a fixed value based on whether the gapless measurement is on a frequency range 1 (FR1) or a frequency range 2 (FR2).

31. The baseband processor of claim 28, wherein the RRC message comprises an RRC reconfiguration message or an RRC resume message, and wherein the RRC response message is received in response to the RRC reconfiguration message or the RRC resume message.

32. The baseband processor of claim 28, wherein the operations further comprise:
receiving UE capability information including a gapless measurement capability parameter indicating that the UE is capable of performing the gapless measurement on the frequency band.

33. The baseband processor of claim 28, wherein the first interruption parameter indicates whether the UE is eligible to use interruptions for the gapless measurement based on a priority of the gapless measurement.

34. A method, comprising:
receiving a radio resource control (RRC) message including a first interruption parameter indicating whether a user equipment (UE) is eligible to use interruptions for a gapless measurement;
transmitting an RRC response message including a second interruption parameter indicating whether interruption is to be used by the UE for the gapless measurement; and
performing the gapless measurement on a frequency band without a measurement gap, based on the first and second interruption parameters.

35. The method of claim 34, wherein second interruption parameter comprises an interruption length parameter indicating a length of interruption to be used to perform the gapless measurement, wherein a value of 0 milliseconds (ms) for the interruption length parameter corresponds to no interruption.

36. The method of claim 34, further comprising:
performing the gapless measurement with a fixed interruption length based on whether the gapless measurement is on a frequency range 1 (FR1) or a frequency range 2 (FR2).

37. The method of claim 34, wherein the RRC message comprises an RRC reconfiguration message or an RRC resume message, and wherein the RRC response message is transmitted in response to the RRC reconfiguration message or the RRC resume message.

38. The method of claim 34, further comprising:
transmitting UE capability information including a gapless measurement capability parameter indicating that the UE is capable of performing the gapless measurement on the frequency band; and
performing the gapless measurement on the frequency band based on the first and second interruption parameters.

39. The method of claim 34, wherein the first interruption parameter indicates whether the UE is eligible to use interruptions for the gapless measurement based on a priority of the gapless measurement.

40. The method of claim 34, further comprising:
transmitting the second interruption parameter based on whether a measurement gap fully covers the gapless measurement, wherein the measurement gap and the gapless measurement are on different frequency bands.
